(19) United States
(12) Patent Application Publication
(10) Pub. No.: US 2015/0234350 A1
(43) Pub. Date: Aug. 20, 2015

(54) DIGITAL HOLOGRAPHIC DISPLAY METHOD AND APPARATUS

(71) Applicant: Electronics and Telecommunications Research Institute, Daejeon (KR)

(72) Inventors: Min Sik PARK, Sejong (KR); Hyun Eui KIM, Cheongju-si Chungcheongbuk-do (KR); Byung Gyu CHAE, Daejeon (KR); Hyon Gon CHOO, Daejeon (KR); Kyung Ae MOON, Daejeon (KR); Jin Woong KIM, Daejeon (KR)

(21) Appl. No.: 14/577,146

(22) Filed: Dec. 19, 2014

(30) Foreign Application Priority Data
Feb. 17, 2014 (KR) 10-2014-0018060

(51) Int. Cl. G03H 1/22; G03H 1/26

(52) U.S. Cl. CPC G03H 1/2294; G03H 1/2205; G03H 1/26; G03H 2001/221

(57) ABSTRACT

The present invention proposes a digital holographic display apparatus including a light generating unit configured to generate coherent light, a spatial light modulator configured to reproduce 3-dimensional hologram images on a space by modulating the coherent light, a vertical viewing angle magnifying unit configured to expand a vertical viewing angle by vertically steering a beam that forms the hologram images through a first mirror, a horizontal viewing angle magnifying unit configured to expand a horizontal viewing angle by steering the beam to top of a table through a second mirror, and a control unit configured to control the special light modulator, the vertical viewing angle magnifying unit and the horizontal viewing angle magnifying unit in order the hologram images to be formed on an observation space for hologram. Accordingly, by expanding the horizontal and vertical viewing angles of hologram images, an observer may observe the hologram images more comfortably.

### CROSS-REFERENCE TO RELATED APPLICATIONS

This application claims the benefit of priority of Korean Patent Application No. 10-2014-0018060 filed on Feb. 17, 2014, all of which are incorporated by reference in their entirety herein.

### BACKGROUND OF THE INVENTION

1. Field of the Invention

The present invention relates to a method and apparatus for holographic display, and more particularly, to a method and apparatus for expanding the viewing angle of a table-top type holographic display.

2. Discussion of the Related Art

In the conventional table-top type digital display, one or a plurality of projectors is disposed under a table, and 2-dimensional images are project over the table, thereby a user is able to watch the corresponding 3-dimensional images. In order to show the 2-dimensional images in 3-dimensional manner to a user, in case of using one projector, by rotating the translucent mirror which is located in the middle of the table and the projector and reflecting 2-dimensional images of respective viewing points projected from the projector over the table through a circular parabolic mirror, 2-dimensional images of different viewing points are provided to both eyes of a user, thereby providing 3-dimensional effect through binocular way, and in case of using a plurality of projectors, by providing images of different viewing points projected from the plurality of projectors through a conical shaped lenticular lens which is located in the middle of the table and projector to both eyes of a user over the table, thereby providing 3-dimensional effect. Since such a method is the method of providing 3-dimensional effect through providing 2-dimensional images to both eyes, it is hard to implement a table-top type digital display in which there is no fatigue from watching the hologram.

In order to implement the table-top type digital holographic display that is available to provide ideal 3-dimensional images that do not cause unpleasant feeling and tiredness of eyes, the 2-dimensional projector that projects 2-dimensional images should not be used, but the spatial light modulator (SLM) that reproduces hologram should be used. The examples of spatial light modulator include a liquid crystal display (LCD) which is used for the conventional TV and the monitor of a computer, a video projector, an electronically addressed SLM (EASLM) which is available to upload the hologram data on a display by controlling respective pixels through switching the electric circuit which is comprised of arrays of thin film transistors (TFTs) such as a digital micro-mirror display (DMD) and a liquid crystal on Silicon (LCoS) which are used for a head mounted display (HMD), an optically addressed SLM (OASLM) that is available to represent the large amount of hologram data on the respective pixels of a display with high speed using optical sensor arrays that transforms light into electrical signals instead of thin film transistors that is hard to perform high speed switching owing to the time constant, an electron-beam addressed SLM (EBSLM) that records the hologram data on a display by controlling each pixel using electron-beam, an acousto-optic SLM (AOSLM) that controls diffraction of incident waves by generating different diffraction grids in a refractive index which is caused from the hologram data being transformed to frequency of sonic signals, a magneto-optic SLM (MOSLM) that controls diffraction of incident waves by controlling the phase of wave front which is entered by changing the magnetic field of a display depending on the hologram data, and the like.

The most important technical issue for commercializing such a table-top type digital holographic display based on the spatial light modulator is about the horizontal and vertical viewing angle. Since the pixel pitch of conventional commercialized panel has a very small viewing angle, there is a problem that hologram reproduced images are not observable properly with binocular eyes through the table-top type digital holographic display.

### SUMMARY OF THE INVENTION

An object of the present invention to solve the problem of described above is to provide a digital holographic display method and apparatus which can improve horizontal and vertical viewing angles.

Another object of the present invention to solve the problem of described above is to provide a digital holographic display method and apparatus which can reproduce a plurality of hologram images on a desired position by controlling the horizontal and vertical parallax.

According to an aspect of the present invention to achieve the object, a digital holographic display apparatus may include a light generating unit configured to generate coherent light, a spatial light modulator configured to reproduce 3-dimensional hologram images on a space by modulating the coherent light, a vertical viewing angle magnifying unit configured to expand a vertical viewing angle by vertically steering a beam that forms the hologram images through a first mirror, and a control unit configured to control the special light modulator and the vertical viewing angle magnifying unit in order the hologram images to be formed on an observation space for hologram.

The first mirror may be a polygon mirror which is rotationally drivable, and an incident beam may be steered to the observation space for hologram vertically by changing location of reflection angle with the first mirror being rotated.

According to another aspect of the present invention to achieve the object, a digital holographic display method may include generating coherent light, reproducing 3-dimensional hologram images on a space by modulating the coherent light performed by a spatial light modulator, expanding a vertical viewing angle by vertically steering a beam that forms the hologram images through a first mirror performed by a vertical viewing angle magnifying unit, and controlling the special light modulator and the vertical viewing angle magnifying unit in order the hologram images to be formed on an observation space for hologram.

According to yet another aspect of the present invention to achieve the object, a digital holographic display apparatus may include a light generating unit configured to generate coherent light, a spatial light modulator configured to reproduce 3-dimensional hologram images on a space by modulating the coherent light, a horizontal viewing angle magnifying unit configured to expand a horizontal viewing angle by steering a beam that forms the hologram images to top of a table through a second mirror, and a control unit configured to control the special light modulator and the horizontal viewing angle magnifying unit in order the hologram images to be formed on an observation space for hologram.

The second mirror may a mirror of 360 degrees rotatable.

The horizontal viewing angle magnifying unit may further include a curbed mirror configured to steer a beam reflected through the second mirror to the top of the table.

According to yet another aspect of the present invention to achieve the object, a digital holographic display method may include generating coherent light, reproducing 3-dimensional hologram images on a space by modulating the coherent light performed by a spatial light modulator, expanding a horizontal viewing angle by steering a beam that forms the hologram images to top of a table through a second mirror performed by a horizontal viewing angle magnifying unit, and controlling the special light modulator and the horizontal viewing angle magnifying unit in order the hologram images to be formed on an observation space for hologram.

According to yet another aspect of the present invention to achieve the object, a digital holographic display apparatus may include a light generating unit configured to generate coherent light, a spatial light modulator configured to reproduce 3-dimensional hologram images on a space by modulating the coherent light, a vertical viewing angle magnifying unit configured to expand a vertical viewing angle by vertically steering a beam that forms the hologram images through a first mirror, a horizontal viewing angle magnifying unit configured to expand a horizontal viewing angle by steering the beam to top of a table through a second mirror, and a control unit configured to control the special light modulator, the vertical viewing angle magnifying unit and the horizontal viewing angle magnifying unit in order the hologram images to be formed on an observation space for hologram.

The first mirror may be a polygon mirror which is rotationally drivable, and an incident beam may be steered to the observation space for hologram vertically by changing location of reflection angle with the first mirror being rotated.

The second mirror may be a mirror of 360 degrees rotatable.

The horizontal viewing angle magnifying unit may further include a curbed mirror configured to steer a beam reflected through the second mirror to the top of the table.

The light generating unit may include a spatial light filter for homogenizing the coherent laser light and a collimation lens for generating planar wave light.

The spatial light modulating unit may spatially modulate the light generated from the light generating unit according to a hologram fringe pattern which is inputted from the control unit.

The control unit may fix the second mirror and rotate the first mirror in order for the hologram images to be vertically projected on the observation space for hologram, and may fixe the first mirror and rotate the second mirror in order for the hologram images to be horizontally projected on the observation space for hologram.

The control unit, in reproducing a plurality of holograms for a reference time, may control the rest of hologram images except for the first hologram image among the multiple numbers of hologram images above to be reproduced as images that are different in the vertical parallax by rotating the first mirror in order that the first hologram image only within the reference time to be reproduced in the same location of horizontal direction.

The control unit may control the rest of hologram images to be reproduced in the same direction with the first hologram image by moving horizontally in multiplying the off-axis phase factor to the rest hologram images which are vertically arranged in the tilted state for the first hologram image.

According to yet another aspect of the present invention to achieve the object, a digital holographic display method may include generating coherent light, reproducing 3-dimensional hologram images on a space by modulating the coherent light performed by a spatial light modulator, expanding a vertical viewing angle by vertically steering a beam that forms the hologram images through a first mirror performed by a vertical viewing angle magnifying unit, expanding a horizontal viewing angle by steering a beam that forms the hologram images to top of a table through a second mirror performed by a horizontal viewing angle magnifying unit, and controlling the special light modulator and the horizontal viewing angle magnifying unit in order the hologram images to be formed on an observation space for hologram.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a conceptual view illustrating the feature of reproducing 3-dimensional images by modulating the wave front of light source through a hologram pattern performed by a spatial light modulator.

FIG. 2 is a block diagram schematically illustrating the construction of the digital holographic display apparatus according to an embodiment of the present invention.

FIG. 3 is a detailed block diagram illustrating the construction of the digital holographic display apparatus according to an embodiment of the present invention in detail.

FIG. 4 is a flow chart schematically illustrating the operation of the control unit of the digital holographic display apparatus according to an embodiment of the present invention.

FIG. 5 to FIG. 7 illustrates the embodiment of expanding the horizontal viewing angle and the vertical viewing angle performed by the digital holographic display apparatus according to an embodiment of the present invention.

### DETAILED DESCRIPTION OF THE INVENTION

The inventive subject matter now will be described more fully hereinafter with reference to the accompanying drawings, in which embodiments of the present invention are shown.

However, the present invention may be embodied in many different forms, modifications, equivalents and alternatives, which are included in the inventive concept and scope, and should not be construed as limited to the embodiments set forth herein.

Although the terms first, second, etc. may be used herein to describe various elements, it will be understood that these elements should not be limited by these terms. These terms are only used to distinguish one element from another. For example, a first element could be termed a second element, and similarly, a second element could be termed a first element without departing from the scope of the present invention. Herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening element present.

The terminology used herein is for the purpose of describing particular embodiments only and is not intended to be limiting of the present invention. As used herein, the singular forms are intended to include the plural forms as well, unless the context clearly indicates otherwise. It will be further understood that the terms “comprise” or “include” etc. when being used in this specification specify the presence of stated features, numbers, steps, operations, elements, components or combination of these things, but do not preclude the presence or addition of one or more other features, numbers, steps, operations, elements, components or combination of these things.

Unless otherwise defined, all terms including technical or scientific terms used herein have the same meaning as commonly understood by one of ordinary skill in the art to which the present invention belongs. It will be further understood that the terms such as those defined in commonly used dictionary should be interpreted as having a meaning that is consistent with their meaning in the context of the relevant art, and will not be interpreted in an idealized or overly formal sense unless expressly so defined herein.

The inventive subject matter now will be described more fully hereinafter by reference to the accompanying drawings, in which embodiments of the present invention are shown. In describing embodiments of the present invention, the same reference numeral is used for the same element even in order to be easily understood throughout the specification, and the redundant description for the same element will be omitted.

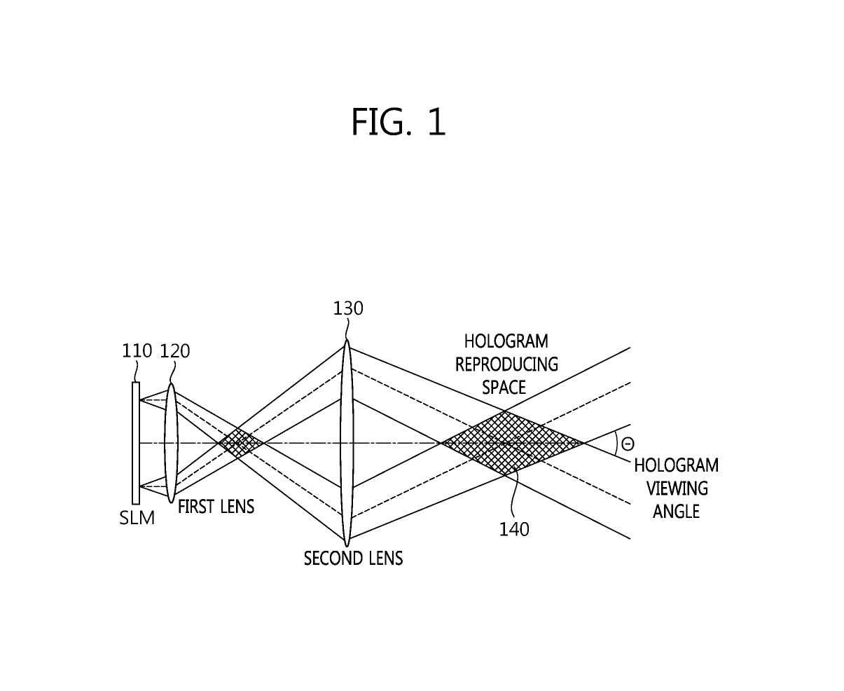

FIG. 1 is a conceptual view illustrating the feature of reproducing 3-dimensional images by modulating the wave front of light source through a hologram pattern performed by a spatial light modulator.

Referring to FIG. 1, the spatial light modulator (SLM) 110 produces 3-dimensional images by modulating the wave front of light source through the hologram pattern. First of all, the light that passes through the spatial light modulator 110 enters a first lens 120 and the direction is changed. In this time, the first lens 120 may be a Fourier lens, and may perform the function of reproducing Fourier hologram. Then, the refracted beam through a second lens 130 may be gradually enlarged and reproduced as hologram images in a hologram reproducing space 140. Herein, the second lens 130 may be a magnifying lens, which is available to perform the function of enlarging the size of hologram producing images and the reproducing space. The angle which is formed by lights refracted through the second lens 130 with being respectively intersected, next to the hologram reproducing space is referred to as a hologram viewing angle, and such an angle may be formed in horizontal and vertical directions, which are referred to as a horizontal viewing angle and a vertical viewing angle, respectively.

According to an embodiment of the present invention, the digital holographic display apparatus that reproduces the hologram with wide horizontal and vertical viewing angle over a table may be further provided with compositions related to rotation for the control of the hologram reproducing beam such as a scanning optical system and a steering apparatus.

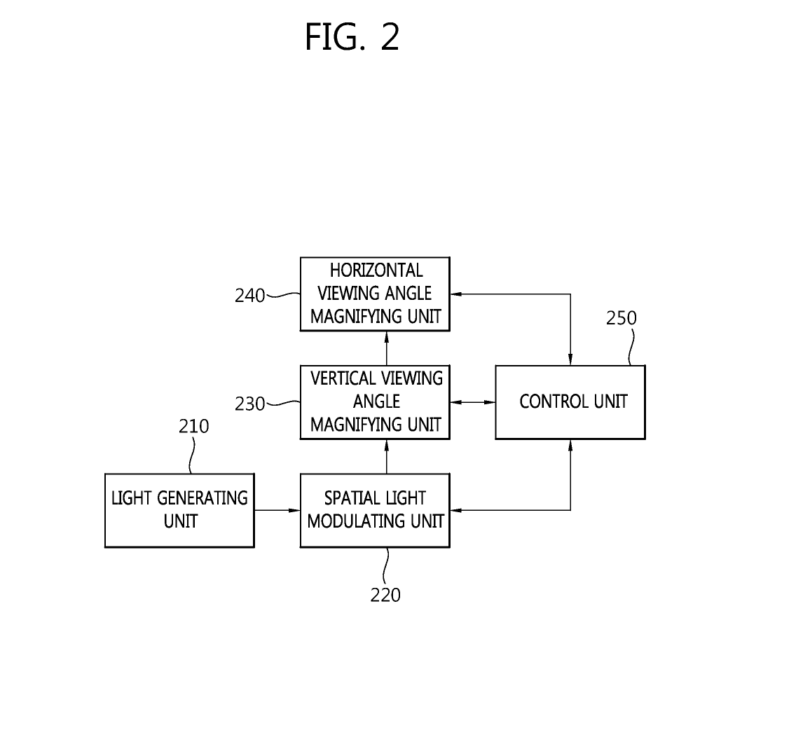

FIG. 2 is a block diagram schematically illustrating the construction of the digital holographic display apparatus according to an embodiment of the present invention. As shown in FIG. 2, the digital holographic display apparatus according to an embodiment of the present invention may include a light generating unit 210, a spatial light modulating unit 220, a vertical viewing angle magnifying unit 230, a horizontal viewing angle magnifying unit 240 and a control unit 250.

Referring to FIG. 2, the light generating unit 210 generates a coherent light for generating hologram images. The light generating unit 210 may include Red, Green and Blue lasers for reproducing color holograms.

The spatial light modulating unit 220 may perform the role of reproducing 3-dimensional hologram images on a space by modulating the light generated by the light generating unit 210. The spatial light modulating unit 220 may receive control signals from the control unit 250. The spatial light modulating unit 220 may spatially modulate the wave field inputted from the light generating unit 210 and provide it to the vertical viewing angle magnifying unit 230 with being controlled by the control unit 250. If it is not required to adjust the horizontal and vertical viewing angles, the modulated beam (may mean the beam forming hologram images) which is modulated through the spatial light modulating unit 220 may be directly reproduced as hologram images.

The vertical viewing angle magnifying unit 230 may magnify the vertical viewing angle by receiving the beam modulated through the spatial light modulating unit 220 and steering it vertically through a polygon mirror which is rotationally drivable. The polygon mirror is the polygon shaped mirror whose each surface is formed of reflector, may reflect the incident beam with being rotated by a motor. The vertical viewing angle magnifying unit 230 may also be operated by receiving control signals from the control unit 250. That is, the control unit 250 may control the vertical and horizontal parallax in order for hologram images to be reproduced in a desired region (the region corresponding to vertical and horizontal positions) of the observation space for hologram.

Although there is a method for circular multiplexing several SLMs spatially in order to expand the horizontal viewing angle, this results in a problem that system expenses are increased and physical tilting is not easy to be performed. Accordingly, in order to solve this problem, the digital holographic display apparatus according to an embodiment of the present invention uses one SLM and utilizes a method for timely multiplexing with 360 degrees through the mirror in which a motor is mounted.

The horizontal viewing angle magnifying unit 240 may receive the beam that passes through the vertical viewing angle magnifying unit 230 as an input and magnify the horizontal viewing angle by steering it to the top of the table through a rotational mirror. The rotational mirror may be the 360 degrees rotational mirror which is driven by the motor. That is, the rotational mirror may expand the horizontal viewing angle by reflecting the incident beam vertically steered with rotating in 360 degrees, and the beam reflected through the rotational mirror may be reflected through a curved mirror and provided with the observation space for hologram on top of the table. As such, with being reflected through the rotational mirror and the curved mirror, the vertical viewing angle may be expanded, and the expanded viewing angle and the size of images may be adjusted by the control signals which are received from the control unit 250.

The control unit 250 may control the spatial light modulating unit 220, the vertical viewing angle magnifying unit 230 and the horizontal viewing angle magnifying unit 240 in order for the hologram images to be formed on the observation space for hologram.

Although there is a method for circular multiplexing several SLMs spatially in order to expand the horizontal viewing angle, this results in a problem that system expenses are increased and physical tilting is not easy to be performed. In order to solve this problem, it is effective to use one SLM and utilize a method for timely multiplexing in 360 degrees through the mirror in which a motor is mounted. In addition, in order to vertically expand the viewing angle, it is required to steer the beam in horizontal direction of the observation space for hologram through the mirror in which a motor is mounted. It is required to control that the hologram whose horizontal parallax is different in horizontal direction of the observation space for hologram is reproduced, and hologram whose horizontal parallax is the same in vertical direction of the observation space for hologram but whose vertical parallax is different is reproduced by generating the hologram having several horizontal/vertical parallaxes.

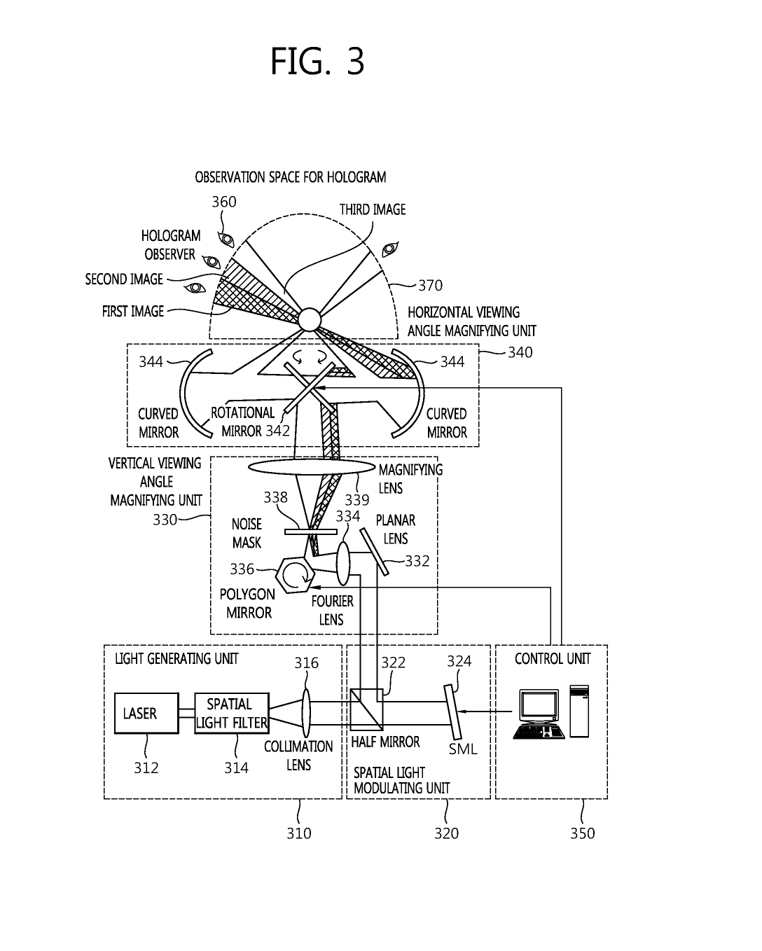

FIG. 3 is a detailed block diagram illustrating the construction of the digital holographic display apparatus according to an embodiment of the present invention in detail.

Referring to FIG. 3, a light generating unit 310 may include a laser 312, a spatial light filter 314 and a collimation lens 316. The laser 312 may include red (R), green (G) and blue color lasers to reproduce color images. The spatial light filter 314 may perform the role of homogenizing the coherent light from the laser 310, and the collimation lens 316 may perform the role of generating planar wave light. The planar wave field generated through the spatial light filter 314 and the collimation lens 316 enters the spatial light modulating unit 320.

The spatial light modulating unit 320 may include a half mirror 322 and a SLM 324. The spatial light modulating unit 320 may spatially modulate the planar wave field inputted by adjusting the angle of the SLM 324 according to a hologram fringe pattern which is inputted from the control unit 350. The beam modulated through the spatial light modulating unit 320 may be irradiated to a vertical viewing angle magnifying unit 330 in order to reproduce hologram images and magnify the size of images. The spatial light modulating unit 320 may be comprised of three spatial light modulators (SLMs) 324 in order to modulate the R, G and B planar wave fields provided for reproducing color hologram images. Either one of LCoS/LCD or DMD may be used for the SLM 324, and the DMD may be used in case that high speed on-off switching of hologram images is required. In addition, the spatial light modulating unit 320 may have the whole area of the SLM 324 be widely used by multiplexing the beam for forming the hologram images.

The vertical viewing angle magnifying unit 330 may include a planar mirror 332, a Fourier lens 334, a polygon mirror 336, a noise mask 338 and a magnifying lens 339. It is not necessarily include all of the elements, but it is enough to include the essential elements for magnifying the vertical viewing angle through the polygon mirror 336. The beam inputted to the vertical viewing angle magnifying unit 330 is reflected through the planar mirror 332 and irradiated to the Fourier lens 334. The beam that passes through the Fourier lens 334 may be reproduced as hologram images and entered into the polygon mirror 336 in which a motor is mounted. The polygon mirror 336 may be rotationally drivable through a motor, and size of the beam that propagates forward to be reflected by the angle formed with the beam that passes through the Fourier lens 334 may be changed, and horizontal viewing angle may be adjusted. That is, the effect of expanding the vertical parallax may be occurred by which the incident beam is steered to the vertical direction of the observation space for hologram 370 according to the change of the location of reflection angle by rotating the polygon mirror 336. Through this, the effect that enables an observer 360 to watch hologram images with a desired location and desired size without incurring so much expense. The beam that is vertically entered should be implemented with the hologram images whose horizontal parallax is identical but vertical parallax is different. For example, the beam which is generated to reproduce one hologram image may be implemented as a plurality of hologram images whose vertical parallax are different such as a first image, a second image, and the like through the vertical viewing angle magnifying unit 330. In some cases, that is, in case that the polygon mirror 336 is rotated and returned to the original location of reflection angle, the control unit 350 may control the horizontal viewing angle magnifying unit 340 such that the hologram image whose horizontal parallax is different from previous hologram image is inputted. The beam reflected through the polygon mirror 336 is irradiated to the horizontal viewing angle magnifying unit 340 in a vertically magnified form through the magnifying lens 339 after noise is removed through the noise mask 338.

The horizontal viewing angle magnifying unit 340 may include a rotational mirror 342 and a curved mirror 344. The horizontal viewing angle magnifying unit 340 receives the beam whose vertical viewing angle is expanded through the vertical viewing angle magnifying unit 330 as an input, and may magnify horizontal viewing angle by irradiating hologram images whose horizontal parallax are different to the observation space for hologram 370 through the rotational mirror 342 which is rotatable in 360 degrees due to a motor mounted and the curved mirrors 344 which are disposed horizontally at both sides based on the rotational mirror 342. The rotational mirror 342 may adjust horizontal viewing angle by controlling the reflection angle of the beam entered with being magnified vertically. The control unit 350 may adjust the angle of the rotational mirror 342 such that hologram images is reproduced in the location and size as an observer 360 wants by calculating the horizontal viewing angle depending on the specific angle formed between the rotational mirror 342 and the incident beam. The rotational mirror 342 is rotationally driven by receiving the control signals from the control unit 350, and the beam is reflected by the reflection angle which is generated by the control signals, and then, the reflected beam is reflected again through the curved mirror 344, thereby hologram images may be reproduced on the observation space for hologram 370. Particularly, the hologram images whose vertical parallax is different may be implemented as the images whose horizontal parallax is different through the horizontal viewing angle magnifying unit 340, therefore, the observer of hologram 360 may observe a plurality of images (a first image, a second image, and so on) that have different vertical/horizontal parallaxes, respectively.

The control unit 350 may generate the hologram images whose horizontal and vertical parallax are different, and may perform the function of precisely controlling the motors which are mounted on the spatial light modulating unit 320, the polygon mirror 336 of the vertical viewing angle magnifying unit 330 and the rotational mirror 342 of the horizontal viewing angle magnifying unit 340 to expand the horizontal/vertical viewing angles.

According to another embodiment of the present invention, the digital holographic display apparatus may include either one of the vertical viewing angle magnifying unit 330 or the horizontal viewing angle magnifying unit 340. For example, the digital holographic display apparatus according to another embodiment of the present invention may include only the vertical viewing angle magnifying unit 330 in order to expand vertical viewing angle. Or, in some cases, the digital holographic display apparatus may include only the horizontal viewing angle magnifying unit 340 without the vertical viewing angle magnifying unit 330 in order to expand horizontal viewing angle. In case that each one of the vertical viewing angle magnifying unit 330 and the horizontal viewing angle magnifying unit 340 is included, the construction and function of the digital holographic display apparatus are the same as described above (Refer to FIG. 3.).

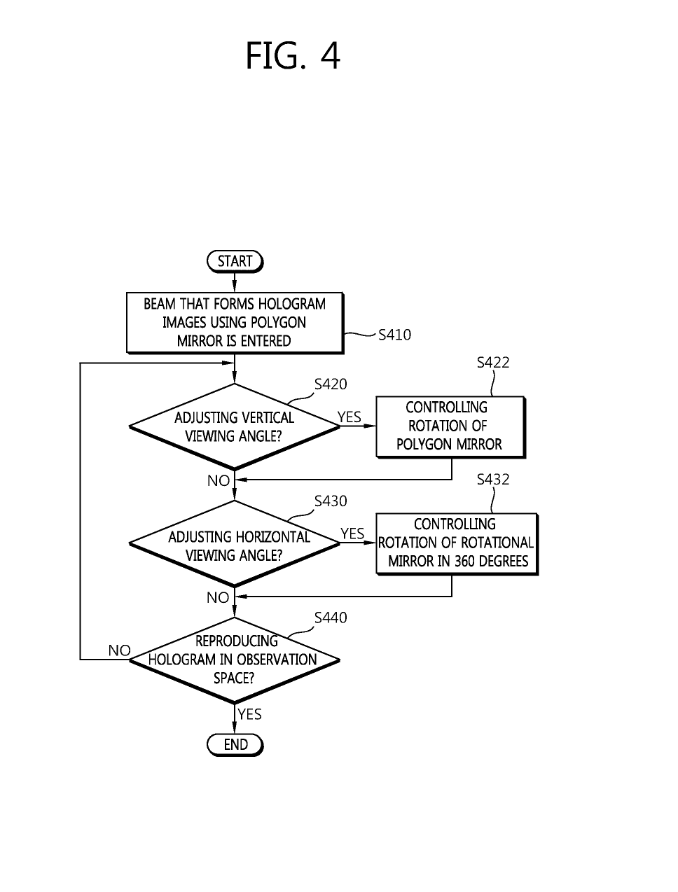

FIG. 4 is a flow chart schematically illustrating the operation of the control unit of the digital holographic display apparatus according to an embodiment of the present invention.

Referring to FIG. 4, the control unit may control the spatial light modulating unit, and control the beam that forms the hologram images using the polygon mirror to be entered through the spatial light modulating unit (step, S410). The control unit determines whether to control the vertical viewing angle of the beam entered as such (step, S420). And the control unit determines whether the control program inputted to the control unit include the process of adjusting vertical viewing angle, and determines whether the vertical viewing angle of the incident beam is different from a predetermined viewing angle (The predetermined value may be changed through a user interface.) by a threshold value. As a result of the determination, in case that it is required to adjust the vertical viewing angle, the control unit controls the polygon mirror to be rotated by driving the motor of the polygon mirror (step, S422). And then, the control unit determines whether to adjust the horizontal viewing angle (step, S430). As a result of the determination, if the vertical viewing angle is not supposed to be adjusted, the step of adjusting vertical viewing angle (step, S422) may be omitted and moves to the step of determining of the adjustment of the horizontal viewing angle (step, S430). The determining of the adjustment of the horizontal viewing angle, like the adjustment of the vertical viewing angle, may be performed through determining whether there is the horizontal viewing angle process with the control program, and determining whether the horizontal viewing angle of the incident beam is different in a threshold value in comparison with a predetermined value. As a result of the determination, in case that it is required to adjust the horizontal viewing angle, the rotation of the rotational mirror may be controlled such that the hologram images have the predetermined horizontal viewing angle by controlling the driving of the motor of the 360 degrees rotational mirror (step, S432). As a result of the determination, if the horizontal viewing angle is not supposed to be adjusted, the step of adjusting the horizontal viewing angle (step, S432) may be omitted. And then, the control unit may determine whether desired hologram images are reproduced in the observation space for hologram (step, S440). This may be determined through whether the hologram images are reproduced with the horizontal/vertical location of the hologram images or desired horizontal/vertical size based on the control program. As a result of the determination, if the hologram images are normally reproduced, the display process may be terminated, but otherwise, returned to the step of determining of the adjustment of the vertical viewing angle and the processes may be repeated.

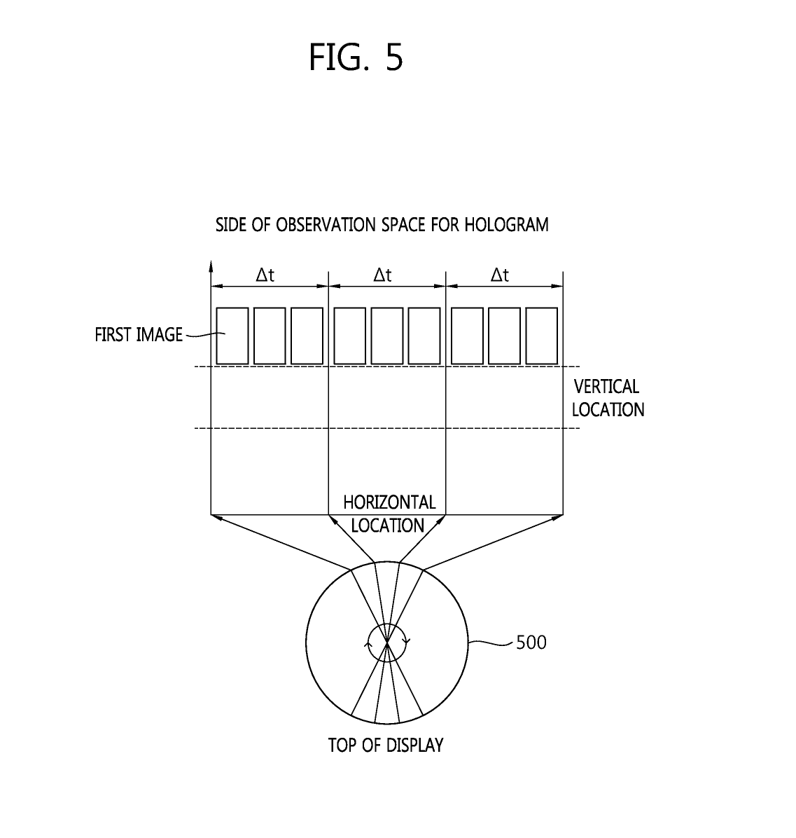

FIG. 5 to FIG. 7 illustrates the embodiment of expanding the horizontal viewing angle and the vertical viewing angle performed by the digital holographic display apparatus according to an embodiment of the present invention.

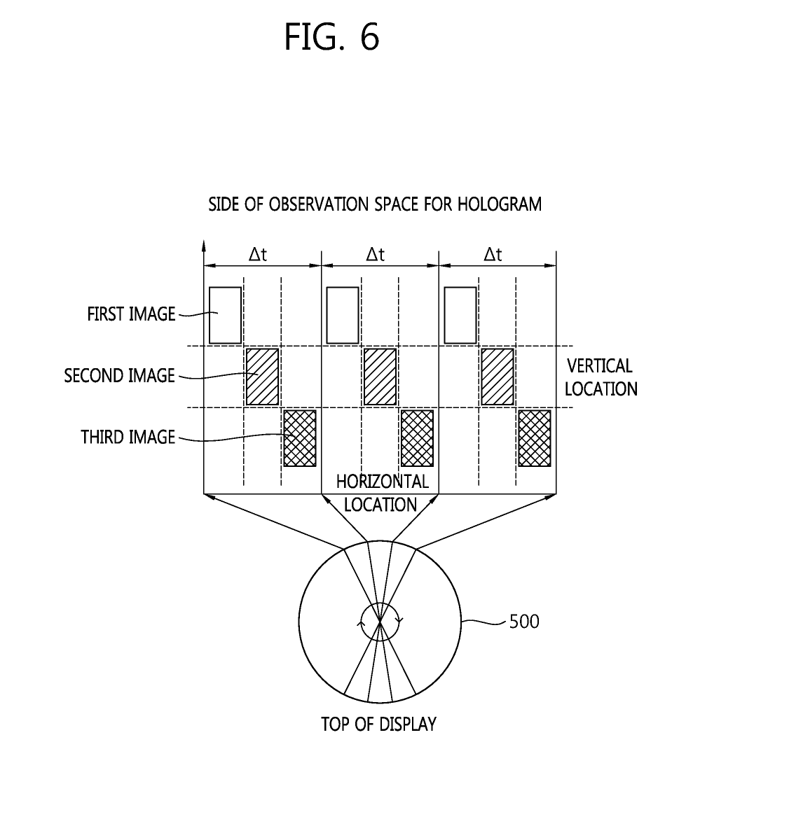

Referring to FIG. 5, in case of securing the horizontal viewing angle without expanding the vertical viewing angle, the digital holographic display apparatus according to an embodiment of the present invention may rotate the rotational mirror of the horizontal viewing angle magnifying unit without rotating the polygon mirror of the vertical viewing angle magnifying unit. In such a case of observing, seen from the side of the observation space for hologram, the hologram pictures are projected with being spread horizontally on the same vertical location with respect to the first images on the upper surface 500 of the display. Through this, it may be possible to achieve the horizontal viewing angle of 360 degrees. Particularly, a plurality of hologram images (may be three images in this embodiment) may be existed for a specific time Δt. In this time, if it is assumed that the specific time Δt is a short time interval that the plurality of hologram images reproduced are not distinguishable with the human perception ability, there is no need to array the plurality of projection images horizontally. This case may be represented by FIG. 6.

FIG. 6 is a conceptual view illustrating the feature of reproducing the hologram images by arranging a plurality of different images vertically on different locations for a certain time interval. As shown in FIG. 6, the digital holographic display apparatus according to an embodiment of the present invention is arranged such that only one projection image (for example, any one of the first image, the second image and the third image) is shown for only one time for a predetermined time Δt, in this time, by rotating the polygon mirror of the vertical viewing angle magnifying unit, the other two projection images except for the projection image are arranged on different vertical locations, thereby they are replaced by the projection images whose vertical parallaxes are different. By this arrangement, the observer that observes different vertical locations observes the images reproduced on the corresponding vertical location, so that a plurality of observers observes different images (for example, the images whose vertical parallaxes are different) multiply.

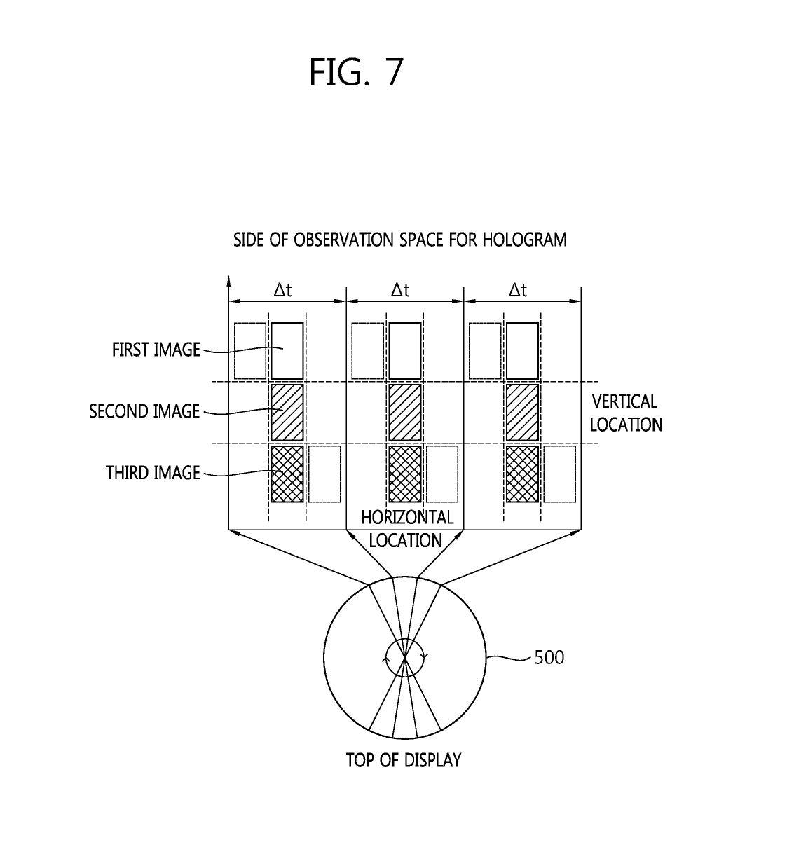

FIG. 7 is a conceptual view illustrating the feature of reproducing the hologram images such that a plurality of different images are differently arranged vertically for a certain time interval, but their horizontal locations are arranged on the same location. As shown in FIG. 7, the control unit of the digital holographic display apparatus according to an embodiment of the present invention may arrange the hologram images in accordance with the horizontal location of a specific image (the second image in this embodiment) by multiplying the off-axis phase factor to the reproduced hologram images, as shown in FIG. 6. That is, by multiplying the off-axis phase factor to the hologram images which are arranged in a slightly tilted state, it may be controlled that the reproduced hologram images move horizontally. According to an embodiment of the present invention, the control unit may reproduce hologram by inputting the off-axis phase factor to the spatial light modulating unit.

So far, the present invention has been described with reference to the drawings and the embodiments, which does not mean the scope of the present invention is not limited thereto, and it should be understood by those skilled in the art, however, that the present invention can be modified or changed in various ways without departing from the technical principles and scope.

What is claimed is:

1. A digital holographic display apparatus, comprising:
a light generating unit configured to generate coherent light;
a spatial light modulator configured to reproduce 3-dimensional hologram images on a space by modulating the coherent light;
a vertical viewing angle magnifying unit configured to expand a vertical viewing angle by vertically steering a beam that forms the hologram images through a first mirror; and
a control unit configured to control the special light modulator and the vertical viewing angle magnifying unit in order the hologram images to be formed on an observation space for hologram.

2. The digital holographic display apparatus of claim 1, wherein the first mirror is a polygon mirror which is rotationally drivable, and wherein an incident beam is steered to the observation space for hologram vertically by changing location of reflection angle with the first mirror being rotated.

3. A digital holographic display method, comprising:
generating coherent light;
reproducing 3-dimensional hologram images on a space by modulating the coherent light performed by a spatial light modulator;
expanding a vertical viewing angle by vertically steering a beam that forms the hologram images through a first mirror performed by a vertical viewing angle magnifying unit; and
controlling the special light modulator and the vertical viewing angle magnifying unit in order the hologram images to be formed on an observation space for hologram.

4. A digital holographic display apparatus, comprising:
a light generating unit configured to generate coherent light;
a spatial light modulator configured to reproduce 3-dimensional hologram images on a space by modulating the coherent light;
a horizontal viewing angle magnifying unit configured to expand a horizontal viewing angle by steering a beam that forms the hologram images to top of a table through a second mirror; and
a control unit configured to control the special light modulator and the horizontal viewing angle magnifying unit in order the hologram images to be formed on an observation space for hologram.

5. The digital holographic display apparatus of claim 4, wherein the second mirror is a mirror of 360 degrees rotatable.

6. The digital holographic display apparatus of claim 4, wherein the horizontal viewing angle magnifying unit further comprises a curbed mirror configured to steer a beam reflected through the second mirror to the top of the table.

7. A digital holographic display method, comprising:
generating coherent light;
reproducing 3-dimensional hologram images on a space by modulating the coherent light performed by a spatial light modulator;
expanding a horizontal viewing angle by steering a beam that forms the hologram images to top of a table through a second mirror performed by a horizontal viewing angle magnifying unit; and
controlling the special light modulator and the horizontal viewing angle magnifying unit in order the hologram images to be formed on an observation space for hologram.

8. A digital holographic display apparatus, comprising:
a light generating unit configured to generate coherent light;
a spatial light modulator configured to reproduce 3-dimensional hologram images on a space by modulating the coherent light;
a vertical viewing angle magnifying unit configured to expand a vertical viewing angle by vertically steering a beam that forms the hologram images through a first mirror;
a horizontal viewing angle magnifying unit configured to expand a horizontal viewing angle by steering the beam to top of a table through a second mirror; and
a control unit configured to control the special light modulator, the vertical viewing angle magnifying unit and the horizontal viewing angle magnifying unit in order the hologram images to be formed on an observation space for hologram.

9. The digital holographic display apparatus of claim 8, wherein the first mirror is a polygon mirror which is rotationally drivable, and wherein an incident beam is steered to the observation space for hologram vertically by changing location of reflection angle with the first mirror being rotated.

10. The digital holographic display apparatus of claim 8, wherein the second mirror is a mirror of 360 degrees rotatable.

11. The digital holographic display apparatus of claim 8, wherein the horizontal viewing angle magnifying unit further comprises a curbed mirror configured to steer a beam reflected through the second mirror to the top of the table.

12. The digital holographic display apparatus of claim 8, wherein the light generating unit comprises:
a spatial light filter for homogenizing the coherent laser light; and
a collimation lens for generating planar wave light.

13. The digital holographic display apparatus of claim 8, wherein the spatial light modulating unit spatially modulates the light generated from the light generating unit according to a hologram fringe pattern which is inputted from the control unit.

14. The digital holographic display apparatus of claim 8, wherein the control unit fixes the second mirror and rotates the first mirror in order for the hologram images to be vertically projected on the observation space for hologram, and fixes the first mirror and rotates the second mirror in order for the hologram images to be horizontally projected on the observation space for hologram.

15. The digital holographic display method of claim 8, wherein the control unit, in reproducing a plurality of holograms for a reference time, controls the rest of hologram images except for the first hologram image among the multiple numbers of hologram images above to be reproduced as images that are different in the vertical parallax by rotating the first mirror in order that the first hologram image only within the reference time to be reproduced in the same location of horizontal direction.

16. The digital holographic display method of claim 15, wherein the control unit controls the rest of hologram images to be reproduced in the same direction with the first hologram image by moving horizontally in multiplying the off-axis phase factor to the rest hologram images which are vertically arranged in the tilted state for the first hologram image.

17. A digital holographic display method, comprising:
generating coherent light;
reproducing 3-dimensional hologram images on a space by modulating the coherent light performed by a spatial light modulator;
expanding a vertical viewing angle by vertically steering a beam that forms the hologram images through a first mirror performed by a vertical viewing angle magnifying unit;
expanding a horizontal viewing angle by steering a beam that forms the hologram images to top of a table through a second mirror performed by a horizontal viewing angle magnifying unit; and
controlling the special light modulator and the horizontal viewing angle magnifying unit in order the hologram images to be formed on an observation space for hologram.
